(19) United States
(12) Patent Application Publication
(10) Pub. No.: US 2026/0115644 A1
(43) Pub. Date: Apr. 30, 2026

(54) CARBON DIOXIDE CAPTURE METHOD

(71) Applicant: UNIVERSITY OF SCIENCE AND TECHNOLOGY OF CHINA, Hefei (CN)

(72) Inventors: Bo LIU, Hefei (CN); Zhiling XIANG, Hefei (CN)

(21) Appl. No.: 18/847,786

(22) PCT Filed: May 18, 2023
(86) PCT No.: PCT/CN2023/094975

§ 371 Date: Sep. 17, 2024

(30) Foreign Application Priority Data
Mar. 18, 2022 (CN) 202210271224.0

(51) Int. Cl. B01D 53/14; B01D 53/00

(52) U.S. Cl. CPC B01D 53/1475; B01D 53/005; B01D 53/1406; B01D 53/1425; B01D 2252/2056; B01D 2257/504

(57) ABSTRACT

Provided is a carbon dioxide capture method, including: absorbing carbon dioxide in a gas with a guanidine sulfate aqueous solution to produce an inclusion complex of the carbon dioxide and the guanidine sulfate, whereby the carbon dioxide is captured from the gas. This application also provides a carbon dioxide capture composition and a use of a guanidine sulfate aqueous solution in capture, purification, storage, and transportation of carbon dioxide.

### CROSS REFERENCE TO RELATED APPLICATION

This patent application is a national stage application of International Patent Application No. PCT/CN2023/094975, filed on May 18, 2023, which claims the benefit and priority of Chinese Patent Application No. 202210271224.0, filed with the China National Intellectual Property Administration on Mar. 18, 2022, the disclosure of which is incorporated by reference herein in its entirety as part of the present application.

### TECHNICAL FIELD

The present disclosure relates to a carbon dioxide capture technique, and in particular to a technique for separating carbon dioxide from a gas mixture using an absorbent.

### BACKGROUND

Carbon dioxide is an important greenhouse gas. With the continuous increase of carbon dioxide emissions of humans, the greenhouse effect is gradually increasing. In order to reduce the carbon dioxide emissions and slow down the trend of global warming, it is very important to develop a carbon dioxide capture technique.

In the industrial sector, the use of a monoethanolamine (MEA) solution to absorb carbon dioxide in an exhaust gas of a coal-fired power plant is an ancient and effective method as follows: The exhaust gas discharged by the coal-fired power plant is allowed to be in contact with an MEA solution in an absorption tower, such that carbon dioxide in the exhaust gas is absorbed and an unabsorbed gas is discharged from a top of the absorption tower. An MEA solution absorbing a large amount of carbon dioxide at a bottom of the absorption tower is pumped to a stripping tower, and the MEA solution in the stripping tower is heated by a steam to 110° C., such that carbon dioxide is released and MEA is regenerated. A regenerated MEA solution is delivered to the absorption tower and continues to participate in a circulation process.

Due to the strong binding of MEA to carbon dioxide, the regeneration of MEA requires a large amount of energy input, which causes a significant decline in the economy of the coal-fired power plant. As a strongly-alkaline solution, the MEA solution has the problem of equipment corrosion, which increases the equipment investment. In addition, MEA is easily oxidized by air. These problems hinder the large-scale industrial application of the MEA adsorption process.

### SUMMARY

In a first aspect, the present disclosure provides a carbon dioxide capture method, including:
absorbing carbon dioxide in a gas with a guanidine sulfate aqueous solution to produce an inclusion complex of the carbon dioxide and the guanidine sulfate, whereby the carbon dioxide is captured from the gas.

Optionally, the carbon dioxide is selectively captured and separated from a gas mixture including the carbon dioxide through the following step:
making the gas mixture in contact with the guanidine sulfate aqueous solution to produce a precipitate of the inclusion complex of the carbon dioxide and the guanidine sulfate, whereby the carbon dioxide is separated from the gas mixture and enters the precipitate.

Optionally, the carbon dioxide capture method further includes the following steps:
separating the inclusion complex or a slurry including the inclusion complex, applying an energy input to the inclusion complex or the slurry including the inclusion complex, and preferably applying stirring, an ultrasound, or heating to release the carbon dioxide and obtain regenerated guanidine sulfate.

Optionally, the carbon dioxide capture method further includes: collecting the released carbon dioxide.

Optionally, the carbon dioxide is captured through the following step:
using the regenerated guanidine sulfate as guanidine sulfate in the guanidine sulfate aqueous solution.

Optionally, the carbon dioxide capture method further includes: after the inclusion complex or the slurry including the inclusion complex is separated, storing and/or transporting the inclusion complex or the slurry including the inclusion complex.

Optionally, the slurry is stored and/or transported under atmospheric pressure.

Optionally, the carbon dioxide and the guanidine sulfate undergo the following reaction:

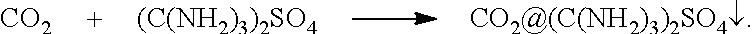

Optionally, the guanidine sulfate aqueous solution is a saturated guanidine sulfate aqueous solution produced by blending water with a guanidine sulfate powder.

In a second aspect, the present disclosure provides a carbon dioxide capture composition, including a guanidine sulfate aqueous solution.

Optionally, the carbon dioxide capture composition is basically composed of water and guanidine sulfate.

Optionally, the carbon dioxide capture composition is a slurry produced by blending a saturated guanidine sulfate aqueous solution with a guanidine sulfate powder.

In a third aspect, the present disclosure provides a use of a guanidine sulfate aqueous solution in capture, purification, storage, and transportation of carbon dioxide.

### DETAILED DESCRIPTION OF THE EMBODIMENTS

In order to at least partially solve the problems such as high energy consumption and equipment corrosion of the existing carbon dioxide capture technique, the present disclosure provides a carbon dioxide capture method which allows the separation of carbon dioxide with low energy consumption and high selectivity through an appropriate absorbent. A carbon dioxide@guanidine sulfate inclusion complex produced by the carbon dioxide capture method enables the economical and effective storage and transportation of carbon dioxide at room temperature and atmospheric pressure, which can avoid the energy consumption problem of storage and transportation of carbon dioxide in a high-pressure or liquefaction manner and does not require the use of a high-pressure-resistant vessel.

To allow the above objective, the present disclosure adopts the following technical solutions:

In the carbon dioxide capture method disclosed in the present disclosure, carbon dioxide in a gas is selectively absorbed with a guanidine sulfate (C₂H₁₂N₆O₄S, CAS No.: 594-14-9 or 1184-68-5) solution. When a carbon dioxide-containing gas is in contact with a guanidine sulfate solution, carbon dioxide reacts with guanidine sulfate to produce an inclusion complex, and the inclusion complex is settled down in the solution. The carbon dioxide-guanidine sulfate inclusion complex has a large density and is settled down at a bottom of the solution. A slurry including a large amount of the carbon dioxide-guanidine sulfate inclusion complex at the bottom of the solution is pumped out, and stirred, subjected to an ultrasound, or heated to release the absorbed carbon dioxide and regenerate a guanidine sulfate solution. The regenerated guanidine sulfate solution can be recycled for capturing carbon dioxide.

A gas mixture is a carbon dioxide-containing gas mixture, which can be a carbon dioxide/nitrogen mixture, a carbon dioxide/nitrogen/oxygen mixture, a carbon dioxide/methane mixture, or a carbon dioxide/methane/nitrogen mixture and can also be a gas mixture with the above-mentioned gas as a main component.

When a partial pressure of carbon dioxide in the gas mixture is too low, the gas mixture in an absorption tower needs to be pressurized to increase the partial pressure of carbon dioxide, thereby improving a removal rate of carbon dioxide.

In order to improve a removal rate and an absorption capacity of carbon dioxide in the gas mixture, a concentration of the guanidine sulfate solution should be increased as much as possible, and a slurry composed of a guanidine sulfate powder and a guanidine sulfate solution is preferably adopted.

A place where the gas mixture is in contact with the guanidine sulfate solution can be a reactor or an absorption tower. In order to increase a gas-liquid contact interface and improve a production efficiency, a spray tower is preferably adopted as the absorption tower.

The absorption of carbon dioxide with a guanidine sulfate solution can be conducted at an appropriate temperature as long as an inclusion complex can be stably generated at this temperature. The absorption can be conducted at room temperature or a low temperature lower than room temperature. From the perspective of enhancing an absorption rate, the absorption is preferably conducted at the low temperature (such as −10° C. to 10° C.).

A carbon dioxide-guanidine sulfate inclusion complex produced after the absorption can be used for regeneration. For example, a slurry including the inclusion complex is pumped out for regeneration. The regeneration can be conducted by destroying a steady state of the inclusion complex with input energy, such as stirring, an ultrasound, or heating. A carbon dioxide gas released from the solution can be collected as a high-purity carbon dioxide gas, such as vacuum collection.

A solid of the carbon dioxide@guanidine sulfate inclusion complex can be stored and transported at room temperature and atmospheric pressure, and a mass fraction of carbon dioxide in the inclusion complex is about 17%.

A reaction equation for the absorption of carbon dioxide in the present disclosure can be as follows:

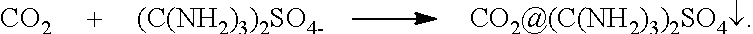

In the present disclosure, the absorbent of guanidine sulfate may be prepared in batches through a neutralization reaction between guanidine carbonate and sulfuric acid or may be prepared by another economical and effective method.

Beneficial effects of the present disclosure may be as follows:
1. In the present disclosure, guanidine sulfate is used to capture carbon dioxide, which has advantages such as cheap and easily-available raw materials, excellent stability, acid resistance, alkali resistance, high-temperature resistance, and no loss in a separation process.
2. Carbon dioxide separated by the method of the present disclosure has an extremely-high purity.
3. The method of the present disclosure has prominent applicability, and can separate carbon dioxide from a variety of gases through highly-selective adsorption.
4. The separation process in the present disclosure involves low energy consumption.
5. The carbon dioxide@guanidine sulfate inclusion complex can store carbon dioxide with a high capacity at room temperature and atmospheric pressure, which is suitable for the storage and transportation of carbon dioxide.

In an embodiment, the present disclosure provides a carbon dioxide capture method, including:
carbon dioxide in a gas is absorbed with a guanidine sulfate aqueous solution to produce an inclusion complex of the carbon dioxide and the guanidine sulfate, whereby the carbon dioxide is captured from the gas.

Guanidine sulfate can be dissolved in water to produce an aqueous solution including guanidinium cations and sulfate anions. The inventors have unexpectedly discovered that guanidinium cations and sulfate anions can selectively bind to a carbon dioxide molecule in a gas to produce an inclusion complex of carbon dioxide and guanidine sulfate, and thus free carbon dioxide can be converted into non-free carbon dioxide binding to guanidine sulfate, thereby allowing the capture of carbon dioxide.

In an embodiment, the carbon dioxide is selectively captured and separated from a gas mixture including the carbon dioxide through the following step:
the gas mixture is allowed to be in contact with the guanidine sulfate aqueous solution to produce a precipitate of the inclusion complex of the carbon dioxide and the guanidine sulfate, whereby the carbon dioxide is separated from the gas mixture and enters the precipitate.

The inventors have unexpectedly discovered that the carbon dioxide capture method in the present disclosure can allow the selective capture of carbon dioxide because guanidine sulfate specifically reacts merely with carbon dioxide to produce an inclusion complex and does not bind to other gases such as nitrogen, oxygen, and methane. Therefore, when a carbon dioxide-containing gas mixture is in contact with a guanidine sulfate aqueous solution, gases other than carbon dioxide remain basically free, and only carbon dioxide is captured by guanidine sulfate, whereby carbon dioxide can be selectively captured from the carbon dioxide-containing gas mixture.

The guanidinium cations and sulfate anion can bind to a carbon dioxide molecule to produce an inclusion complex of carbon dioxide and guanidine sulfate. The inclusion complex is hardly soluble in water, and thus is a precipitate. Therefore, the free carbon dioxide gas is captured in a solid inclusion complex precipitate, thereby allowing the easy and efficient separation of carbon dioxide from other gases in the gas mixture.

Examples of gases other than carbon dioxide in the carbon dioxide-containing gas mixture can include any gas that does not react with guanidine sulfate, and preferably any gas that does not react with both guanidine sulfate and water, such as nitrogen, oxygen, and methane. Examples of the gas mixture can be a carbon dioxide/nitrogen mixture, a carbon dioxide/nitrogen/oxygen mixture, a carbon dioxide/methane mixture, or a carbon dioxide/methane/nitrogen mixture and can also be a gas mixture with the above-mentioned gas as a main component.

In an embodiment, the carbon dioxide capture method further includes the following steps:
the inclusion complex or a slurry including the inclusion complex is separated, an energy input is applied to the inclusion complex or the slurry including the inclusion complex, and stirring, an ultrasound, or heating is preferably applied to release the carbon dioxide and obtain regenerated guanidine sulfate.

The poor solubility of the inclusion complex facilitates the separate separation of the inclusion complex for subsequent treatments. After the inclusion complex of the carbon dioxide and the guanidine sulfate is produced, the inclusion complex settles, and a slurry including the inclusion complex can be produced at a bottom of the aqueous solution. The inclusion complex can be separated for subsequent treatments by a conventional method as long as a separation process essentially does not cause the release of carbon dioxide from the inclusion complex. For example, a solid inclusion complex can be obtained through filtration and natural drying. For example, a solid inclusion complex can be obtained through standing, supernatant removal, and natural drying. The slurry including the inclusion complex (namely, a mixture of a solid inclusion complex and a small amount of an aqueous phase) can also be separated for subsequent treatments by a conventional method as long as a separation process essentially does not cause the release of carbon dioxide from the inclusion complex. For example, the slurry at the bottom can be pumped out. For example, the slurry at the bottom can be obtained through supernatant removal. Then, an energy input is applied to the inclusion complex or the slurry including the inclusion complex to release the carbon dioxide. When the inclusion complex receives enough energy input, the carbon dioxide can be released from the inclusion complex to produce guanidine sulfate unbound to carbon dioxide. Any suitable energy input can be adopted, such as stirring, an ultrasound, heating, and irradiation. The stirring, the ultrasound, or the heating is preferably applied because the stirring, the ultrasound, or the heating is inexpensive and easy to implement in terms of the process and equipment. The inventors have unexpectedly discovered that carbon dioxide can be released at a much lower energy input than the related technologies. For example, the energy input required by the inclusion complex is much lower than an energy input required for releasing carbon dioxide from carbon dioxide-absorbed MEA. When carbon dioxide is released, regenerated guanidine sulfate can be obtained.

In an embodiment, the carbon dioxide capture method further includes: the released carbon dioxide is collected. Since only carbon dioxide is released during the above process, the collected carbon dioxide can have an extremely-high purity. Therefore, the carbon dioxide capture method of the present disclosure can also serve as a method for purifying carbon dioxide.

In an embodiment, the carbon dioxide is captured through the following step:
the regenerated guanidine sulfate is used as guanidine sulfate in the guanidine sulfate aqueous solution.

The regenerated guanidine sulfate obtained after the release of carbon dioxide has the same properties as the original guanidine sulfate, and can be recycled for the carbon dioxide capture method of the present disclosure. The recycling of guanidine sulfate is easy to implement, and thus the carbon dioxide capture can be allowed at a low comprehensive cost.

In an embodiment, the carbon dioxide capture method further includes: after the inclusion complex or the slurry including the inclusion complex is separated, the inclusion complex or the slurry including the inclusion complex is stored and/or transported. That is, the inclusion complex or the slurry including the inclusion complex can serve as a carrier for storage and/or transportation of carbon dioxide. In this way, the carbon dioxide can be released from the inclusion complex or the slurry including the inclusion complex at a desired time point and site.

In an embodiment, the slurry is stored and/or transported under atmospheric pressure. Whether the inclusion complex of the carbon dioxide and the guanidine sulfate releases the carbon dioxide into an environment in the absence of an energy input is mainly related to a temperature and a partial pressure of oxygen in the environment. The inventors have found that a partial pressure of carbon dioxide required to maintain the inclusion complex increases with the increase of a temperature. For example, at 25° C., as long as a partial pressure of carbon dioxide in an environment is higher than 52 kPa, the inclusion complex will not release the carbon dioxide. When a temperature in an environment arises to 35° C., in order to prevent the inclusion complex from releasing the carbon dioxide, a partial pressure of carbon dioxide in the environment needs to be higher than 75 kPa. However, as mentioned above, even at a temperature of 35° C. which is quite high for daily production and life, a partial pressure of carbon dioxide required to prevent the carbon dioxide from being released is still lower than 1 atmosphere. Therefore, at daily ambient temperatures such as room temperature, the storage and/or transportation of the inclusion complex or the slurry including the inclusion complex can be conducted with a gas-tight container that is generally used under atmospheric pressure without increasing a pressure or deceasing a temperature. Correspondingly, there is no need for specialized high-pressure or low-temperature equipment, resulting in the significant reduction of a cost.

Moreover, due to a low molecular weight of guanidine sulfate as a collector itself, a weight proportion (which can also be called a capacity) of carbon dioxide captured in the collector can reach about 17%. Therefore, the present disclosure actually provides a method for efficient and economical storage and transportation of carbon dioxide using a carbon dioxide@guanidine sulfate inclusion complex.

In an embodiment, the carbon dioxide and the guanidine sulfate undergo the following reaction:

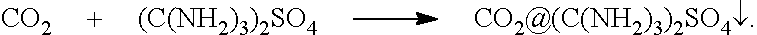

That is, the inclusion complex of the carbon dioxide and the guanidine sulfate is produced.

Specifically, the reaction can be as follows:

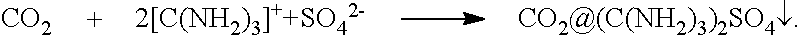

In an embodiment, the guanidine sulfate aqueous solution is a saturated guanidine sulfate aqueous solution produced by blending water with a guanidine sulfate powder.

An excess amount of the guanidine sulfate powder can be blended with the water to produce the saturated guanidine sulfate aqueous solution. When sulfate anions and guanidinium cations in the aqueous solution react with carbon dioxide to produce an inclusion complex to make guanidine sulfate consumed, the guanidine sulfate powder can be supplemented to increase a carbon dioxide capacity of the system. Guanidine sulfate in a powder form is adopted because the guanidine sulfate powder is easily dissolved, which facilitates the ion supplementation.

In an embodiment, the present disclosure provides a carbon dioxide capture composition, including a guanidine sulfate aqueous solution.

As mentioned above, the carbon dioxide capture composition including the guanidine sulfate aqueous solution can allow the capture of carbon dioxide by producing an inclusion complex of carbon dioxide and guanidine sulfate.

In an embodiment, the carbon dioxide capture composition is basically composed of water and guanidine sulfate, and is most preferably composed of merely water and guanidine sulfate. Such a carbon dioxide capture composition has the strongest capture selectivity for carbon dioxide.

In an embodiment, the carbon dioxide capture composition is a slurry produced by blending a saturated guanidine sulfate aqueous solution with a guanidine sulfate powder. As mentioned above, such a carbon dioxide capture composition provides a high capacity for carbon dioxide through an excess amount of the guanidine sulfate powder, and maintains a high carbon dioxide absorption efficiency of the saturated guanidine sulfate aqueous solution.

In an embodiment, the present disclosure provides a use of a guanidine sulfate aqueous solution in capture, purification, storage, and transportation of carbon dioxide. As mentioned above, the guanidine sulfate aqueous solution can be used to capture carbon dioxide, especially to selectively capture carbon dioxide from a carbon dioxide-containing gas mixture. The guanidine sulfate aqueous solution can also be used to purify carbon dioxide, so as to provide carbon dioxide with an extremely-high purity. The guanidine sulfate aqueous solution can also be used to store and transport carbon dioxide with an absorption rate as high as about 17%, and can allow the storage and transportation of carbon dioxide at room temperature and atmospheric pressure.

To make the objectives, features, and advantages of the present disclosure clear and comprehensible, specific implementations of the present disclosure will be described in detail below in conjunction with examples.

### Example 1

27 g of a guanidine sulfate powder and 7 mL of water were added to a high-pressure reactor that had a volume of 50 mL and was provided with mechanical stirring, a gas in the high-pressure reactor was replaced with a carbon dioxide/nitrogen gas mixture (15 mol % of carbon dioxide+85 mol % of nitrogen) of 1 MPa three times, then a gas pressure in the high-pressure reactor was set to 1 MPa, and a valve of the high-pressure reactor was closed, so as to produce a reaction system. The reaction system was stirred at 0° C. for 24 h to make the gas mixture in full contact with a guanidine sulfate solution. A content of carbon dioxide in a residual gas was analyzed by a gas chromatograph. According to an analysis result, a removal rate of carbon dioxide during the above process was 49%. Carbon dioxide removed from the gas mixture was totally absorbed by the guanidine sulfate solution, which allowed the capture of carbon dioxide.

Carbon dioxide absorbed by the guanidine sulfate solution could be completely released by applying an ultrasound. The guanidine sulfate solution could be regenerated.

### Example 2

The operations in this example were the same as those in Example 1, except that a carbon dioxide/nitrogen gas mixture (15 mol % of carbon dioxide+85 mol % of nitrogen) was adopted, and a gas pressure in the high-pressure reactor was set to 3 MPa. According to an analysis result, a removal rate of carbon dioxide was 82%.

### Example 3

The operations in this example were the same as those in Example 1, except that a carbon dioxide/nitrogen gas mixture (15 mol % of carbon dioxide+85 mol % of nitrogen) was adopted, and a gas pressure in the high-pressure reactor was set to 6 MPa. According to an analysis result, a removal rate of carbon dioxide was 91%.

### Example 4

The operations in this example were the same as those in Example 1, except that a carbon dioxide/nitrogen gas mixture (30 mol % of carbon dioxide++70 mol % of nitrogen) was adopted, and a gas pressure in the high-pressure reactor was set to 1 MPa. According to an analysis result, a removal rate of carbon dioxide was 77%.

### Example 5

The operations in this example were the same as those in Example 1, except that a carbon dioxide/nitrogen gas mixture (30 mol % of carbon dioxide++70 mol % of nitrogen) was adopted, and a gas pressure in the high-pressure reactor was set to 3 MPa. According to an analysis result, a removal rate of carbon dioxide was 91%.

### Example 6

According to measurement results, 11.3 g of guanidine sulfate absorbed 2.3 g of carbon dioxide in a solid precipitate produced after absorption, that is, a mass percentage of carbon dioxide in a carbon dioxide@guanidine sulfate inclusion complex was 17%, which was consistent with a theoretical value. The carbon dioxide@guanidine sulfate inclusion complex can be stably stored in a gas-tight ordinary glass or plastic bottle at room temperature, indicating that the storage and transportation of the carbon dioxide@guanidine sulfate inclusion complex does not require a high-pressure vessel or a low temperature.

The present disclosure discloses a carbon dioxide capture method where carbon dioxide in a gas mixture is selectively absorbed with a guanidine sulfate solution. When a carbon dioxide-containing gas mixture is in contact with a guanidine sulfate solution, carbon dioxide reacts with guanidine sulfate to produce an inclusion complex, and the inclusion complex is settled down in the solution. In the present disclosure, a guanidine sulfate aqueous solution is used to capture carbon dioxide, which has advantages such as cheap and easily-available raw materials, excellent stability, acid resistance, alkali resistance, high-temperature resistance, and no loss in a separation process. Carbon dioxide separated by the method of the present disclosure has an extremely-high purity.

The above are merely specific implementations of the present disclosure, but are not intended to limit the protection scope of the present disclosure. Any variation or replacement readily conceived by a person skilled in the art within the technical scope disclosed in the present disclosure shall fall within the protection scope of the present disclosure. Therefore, the protection scope of the present disclosure shall be subject to the protection scope of the claims.

1. A carbon dioxide capture method, comprising:
absorbing carbon dioxide in a gas with a guanidine sulfate aqueous solution to produce an inclusion complex of the carbon dioxide and the guanidine sulfate, whereby the carbon dioxide is captured from the gas.

2. The carbon dioxide capture method according to claim 1, wherein the carbon dioxide is selectively captured and separated from a gas mixture comprising the carbon dioxide through the following step:
making the gas mixture in contact with the guanidine sulfate aqueous solution to produce a precipitate of the inclusion complex of the carbon dioxide and the guanidine sulfate, whereby the carbon dioxide is separated from the gas mixture and enters the precipitate.

3. The carbon dioxide capture method according to claim 1, further comprising the following steps:
separating the inclusion complex or a slurry comprising the inclusion complex, applying an energy input to the inclusion complex or the slurry comprising the inclusion complex, and preferably applying stirring, an ultrasound, or heating to release the carbon dioxide and obtain regenerated guanidine sulfate.

4. The carbon dioxide capture method according to claim 3, further comprising: collecting the released carbon dioxide.

5. The carbon dioxide capture method according to claim 3, wherein the carbon dioxide is captured through the following step:
using the regenerated guanidine sulfate as guanidine sulfate in the guanidine sulfate aqueous solution.

6. The carbon dioxide capture method according to claim 3, further comprising: after the inclusion complex or the slurry comprising the inclusion complex is separated, storing and/or transporting the inclusion complex or the slurry comprising the inclusion complex.

7. The carbon dioxide capture method according to claim 6, wherein the slurry is stored and/or transported under atmospheric pressure.

8. The carbon dioxide capture method according to claim 1, wherein the carbon dioxide and the guanidine sulfate undergo the following reaction:

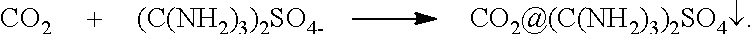

9. The carbon dioxide capture method according to claim 1, wherein the guanidine sulfate aqueous solution is a saturated guanidine sulfate aqueous solution produced by blending water with a guanidine sulfate powder.

10. A carbon dioxide capture composition, comprising a guanidine sulfate aqueous solution.

11. The carbon dioxide capture composition according to claim 10, wherein the carbon dioxide capture composition is basically composed of water and guanidine sulfate.

12. The carbon dioxide capture composition according to claim 11, wherein the carbon dioxide capture composition is a slurry produced by blending a saturated guanidine sulfate aqueous solution with a guanidine sulfate powder.

13. (canceled)
